(19) United States
(12) Patent Application Publication
(10) Pub. No.: US 2017/0363904 A1
(43) Pub. Date: Dec. 21, 2017

(54) REFLECTOR LAMINATE

(71) Applicant: 3M INNOVATIVE PROPERTIES COMPANY, St. Paul, MN (US)

(72) Inventors: Brian A. KINDER, Woodbury, MN (US); Michael L. RUEGSEGGER, Woodbury, MN (US)

(21) Appl. No.: 15/538,609

(22) PCT Filed: Dec. 18, 2015
(86) PCT No.: PCT/US2015/066797

§ 371 Date: Jun. 21, 2017

Related U.S. Application Data
(60) Provisional application No. 62/096,239, filed on Dec. 23, 2014.

(51) Int. Cl. G02F 1/1333; F21V 8/00; G02F 1/1335

(52) U.S. Cl. CPC G02F 1/133308; G02F 1/133615; G02B 6/0081; G02F 2001/133314

(57) ABSTRACT

A reflector laminate comprises a reflector having a first major surface and a second major surface opposite the first major surface, and a visible light non-transmissive adhesive tape having a major adhesive surface and a second major surface. The adhesive surface is in contact with the first major surface of the reflector and at least a portion of the adhesive tape extends beyond the edge of the reflector.

### FIELD

This invention relates to reflector laminates that minimize light leakage in backlight modules for liquid crystal displays (LCDs) and to backlight modules containing the reflector laminates.

### BACKGROUND

LCDs use a backlight module to generate a uniform light source to illuminate the image generating panel. The backlight module typically includes a reflector, a light guide plate, various enhancement films, light emitting diodes (LEDs) and a frame.

FIG. 1 shows a typical backlight module 100. In backlight module 100, frame 102, which is typically white, supports light source 104. Light source 104, which is typically LEDs, is positioned adjacent an incident surface of light guide place 106. Frame 102 supports light guide plate 106 and light recycling stack 108 by their edges. Reflector 110 is located below light guide plate 106 and is attached to the bottom of frame 102 by pieces of tape 112, commonly referred to as “perimeter tape.” Reflector 110 reflects light into light guide plate 106. Some designs (not shown) use a metal tray into which the framed is placed such that the reflector is free to float between the tray and the frame.

Typically, as shown in FIG. 1, a gap 114 exists between reflector 110 and frame 102 (that is, a gap exists around the perimeter of the reflector). Light can escape from gap 114. This escaped light can interfere with other components in the device in which the backlight module is incorporated. For example, the light can interfere with a camera sensor in a mobile phone or other handheld device. The escaped light can also cause aesthetic defects such as undesirable light leakage from buttons or ports (for example, headphone jack, etc.) in the device. In addition, light can escape through perimeter tape 112, either through a clear adhesive or thin scrim, or through the frame, which is typically constructed of a thin white material.

### SUMMARY

In view of the foregoing, we recognize that light leakage is a problem in LCD modules. Furthermore, we recognize that when the reflector is a multilayer interference reflector, the problem of light leakage may be exacerbated. Even though multilayer interference reflectors sometimes have a black coating on the backside, light can couple into the reflector. This light can then be guided through the reflector and eventually escape from the reflector's edges causing additional light leakage.

We have discovered that light leakage in LCD modules can be minimized or eliminated by replacing the black coating on the backside of the reflector with a visible light non-transmissive adhesive tape that extends beyond the edge of the reflector. The visible light non-transmissive adhesive tape serves to manage stray light and to attach the reflector to the LCD module frame eliminating the need for perimeter tape.

In some applications, light leakage may be sufficiently minimized by extending only a portion of the tape beyond the edge of the reflector (for example, in areas where there are ports). In other applications, particularly when a multilayer interference reflector is utilized, it may be preferable to entirely seal all edges of the reflector so that light leakage is nearly completely eliminated. An additional benefit of completely sealing the edges of the reflector is that dust and debris cannot enter between the reflector and the light guide.

Briefly, in one aspect, the present invention provides a reflector laminate comprising a reflector having a first major surface and a second major surface opposite the first major surface, and a visible light non-transmissive adhesive tape having a major adhesive surface and a second major surface. The adhesive surface is in contact with the first major surface of the reflector and at least a portion of the adhesive tape extends beyond the edge of the reflector.

In another aspect, the present invention provides a backlight module comprising a frame, a reflector having a first major surface and a second major surface opposite the first major surface, a visible light non-transmissive adhesive tape having a major adhesive surface and a second major surface, a light guide positioned proximate the second major surface of the reflector and a light source for injecting light into an edge of the light guide. The adhesive surface of the visible light non-transmissive tape is in contact with the first major surface of the reflector and at least a portion of the adhesive tape extends beyond the edge of the reflector to attach the reflector to the frame.

As used herein, the term “visible light” includes wavelength ranges in the visible and near-visible such as, for example, 400-700 nm and the term “non-transmissive” means less than about 0.1% transmission.

### BRIEF DESCRIPTION OF THE DRAWINGS

FIG. 1 is a schematic cross-sectional view of a backlight module of the prior art.

FIG. 2 is a schematic cross-sectional view of a reflector laminate of the present invention.

FIG. 3 is a schematic cross-sectional view of a reflector laminate of the present invention.

FIG. 4 is a schematic cross-sectional view of a reflector laminate of the present invention.

FIG. 5 is a schematic cross-sectional view of a backlight module of the present invention.

FIG. 6 is a schematic cross-sectional view of a backlight module of the present invention.

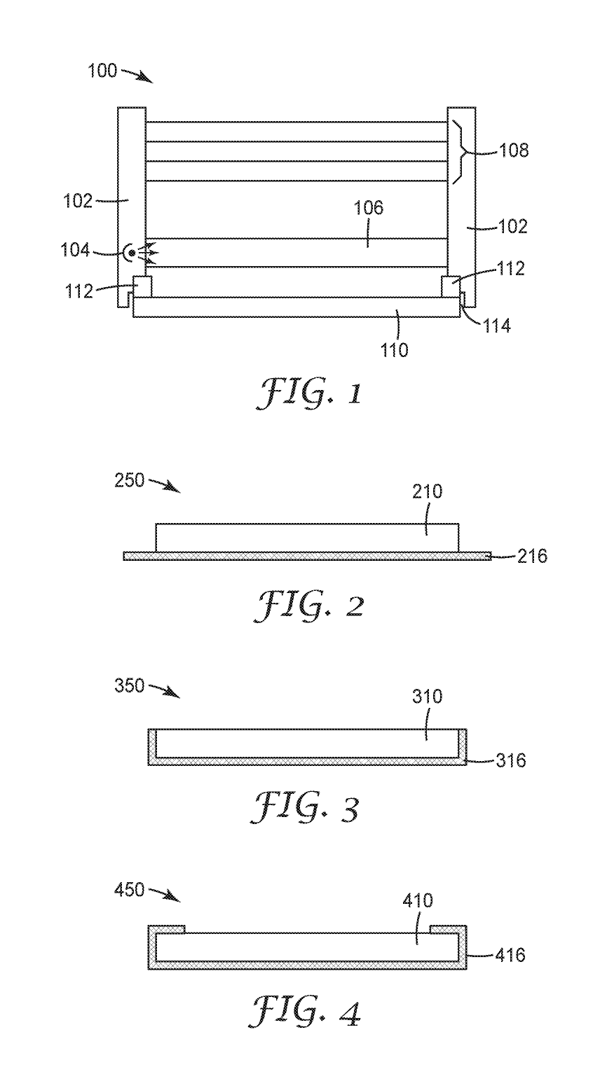

### DETAILED DESCRIPTION

In the following detailed description, reference is made to the accompanying drawings that form a part hereof, and in which are shown by way of illustration several specific embodiments. It is to be understood that other embodiments are contemplated and may be made without departing from the scope or spirit of the present disclosure. The following detailed description, therefore, is not to be taken in a limiting sense.

All scientific and technical terms used herein have meanings commonly used in the art unless otherwise specified. The definitions provided herein are to facilitate understanding of certain terms used frequently herein and are not meant to limit the scope of the present disclosure.

Unless otherwise indicated, all numbers expressing feature sizes, amounts, and physical properties used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein.

As used in this specification and the appended claims, the singular forms “a,” “an,” and “the” encompass embodiments having plural referents, unless the content clearly dictates otherwise. As used in this specification and the appended claims, the term “or” is generally employed in its sense including “and/or” unless the content clearly dictates otherwise.

Spatially related terms, including but not limited to, “lower,” “upper,” “beneath,” “below,” “above,” and “on top,” if used herein, are utilized for ease of description to describe spatial relationships of an element(s) to another. Such spatially related terms encompass different orientations of the device in use or operation in addition to the particular orientations depicted in the figures and described herein. For example, if an object depicted in the figures is turned over or flipped over, portions previously described as below or beneath other elements would then be above those other elements.

As used herein, “have”, “having”, “include”, “including”, “comprise”, “comprising” or the like are used in their open ended sense, and generally mean “including, but not limited to.” It will be understood that the terms “consisting of” and “consisting essentially of” are subsumed in the term “comprising,” and the like.

The reflector laminates of the present invention comprise a reflector. Reflectors are used in the backside of backlight modules to redirect otherwise wasted light back toward the LCD panel. The reflector can comprise aluminum foil, a white surface (for example, polyethylene terephthalate (PET)), silver film or any high reflectivity mirror. A preferred high reflectivity mirror is a thin film interference stack. Such stacks can be made economically, and can be designed to provide high reflectivity over a desired wavelength band, such as the human visible wavelength spectrum or the output spectrum of a specified light source or the sensitivity spectrum of a specified detector. The stacks can also provide reflectivity over a range of angles of the incident light. Excellent reflectivity can usually be achieved—at a particular wavelength, or even over the entire wavelength range of interest—for normally incident light and for moderate angles of incidence. This performance is usually adequate for the intended end-use application. Examples of interference reflectors, such as multilayer interference reflectors, include those described in U.S. Pat. No. 6,208,466 (Liu et al.); U.S. Pat. No. 5,825,543 (Ouderkirk et al.); U.S. Pat. No. 5,783,120 (Ouderkirk et al.); U.S. Pat. No. 5,882,774 (Jonza et al.); U.S. Pat. No. 5,612,820 (Schrenk et al.) and U.S. Pat. No. 5,486,949 (Schrenk et al.). In some cases, wide angle mirror systems can be used to improve the reflectivity over a broad range of wavelengths and angles, as described for example in U.S. Patent Application Publication No. 2008-0037127 (Weber).

For some applications, such as a hand-held display backlight, a birefringent multilayer stack adapted to reflect visible light can be used to reflect and distribute some of the light that is injected into the edge of a light guide. One such birefringent multilayer stack is a multilayer interference reflector ESR (Enhanced Specular Reflective) film available from 3M Company. In some backlights the ESR film is suspended below the light guide such that the ESR film is immersed in a very low refractive index medium such as air, for optimal performance. In other backlights, the reflector is laminated to the light guide with an optical adhesive.

Interference reflectors, such as multilayer interference reflectors, can be made from inorganic materials, such as alternating layers of metals or oxides, and can be electrically conductive or non-conductive reflectors. In some cases, multilayer interference reflectors can be made from organic materials. In one aspect of the invention, the reflector is a polymeric multilayer interference reflector.

Multilayer interference reflector stacks include typically tens, hundreds, or thousands of microlayers, composed of optical materials “a” and “b” arranged in an interference stack, for example a quarter-wave stack. Optical materials “a, b” can be any suitable materials known to have utility in interference stacks, whether inorganic (such as TiO2, SiO2, CaF, or other suitable materials) or organic, for example, polymeric (e.g. polyethylene naphthalate (PEN), polymethyl methacrylate (PMMA), polyethylene terephthalate (PET), acrylic, and other suitable materials). The stack may have an all-inorganic, all-organic, or mixed inorganic/organic construction. The stack can include more materials than just materials “a, b”, for example, additional materials “c”, “d”, and the like can be included in the stack. The microlayers can be isotropic, or they can be birefringent microlayers, or they can be a combination of isotropic microlayers and birefringent microlayers. Birefringent microlayers may be utilized in symmetric reflective systems, which reflect normally incident light of any polarization substantially equally, or in asymmetric reflective systems, which have high reflectivity for normally incident light of one polarization and lower reflectivity for normally incident light of an orthogonal polarization.

A microlayer has an optical thickness (physical thickness multiplied by refractive index) that is typically a fraction of a wavelength of light. The microlayers are arranged in repeating patterns, referred to as optical repeat units (ORUs), for example where the optical thickness of the ORU is half the wavelength of light in the wavelength range of interest. Such thin layers make possible the constructive or destructive interference of light responsible for the wavelength-dependent reflection and transmission properties of the stack. The ORU can be the pair of layers “ab”, but other arrangements are also possible, such as the arrangements discussed in U.S. Pat. No. 5,103,337 (Schrenk et al.), U.S. Pat. No. 3,247,392 (Thelen), U.S. Pat. No. 5,360,659 (Arends et al.), and U.S. Pat. No. 7,019,905 (Weber). A thickness gradient, wherein the optical thickness of the ORUs changes along a thickness dimension of the stack, can be incorporated into the stack to widen the reflection band, if desired. The stack need not be flat or planar over its entire extent, but can be shaped, molded, or embossed into non-planar shapes as desired. At least locally, however, the microlayers can be said to lie or extend substantially parallel to a local x-y coordinate plane.

In some cases, alternating materials of suitable refractive index, microlayer thickness profile across the stack, and total number of microlayers can be selected to provide a stack having characteristics such as: a reflection band extending throughout the visible region and extending into the near infrared, having sharp left- and right-band edges, and having a high average reflectivity throughout at least the visible region (and for some applications also throughout the near infrared) of at least 70%, 80%, or 90% or more. ESR film sold by 3M Company, which utilizes a birefringent multilayer stack, can have an average reflectivity of greater than 98% throughout the visible region.

The film stack can be entirely polymeric, and can be made by a coextrusion process and a stretching process to induce an appropriate amount of birefringence in the microlayers to enhance reflectivity. In some cases, the film stack can include or be limited to inorganic materials, and may be made by vacuum evaporation techniques. Reference is made to U.S. Pat. No. 6,590,707 (Weber) for a birefringent thin film stack that utilizes inorganic materials.

Typically, in backlight modules for LCDs, the reflector has a black coating on its backside (that is, the side opposite the light guide plate. In the reflector laminates of the present invention, this conventional black coating is replaced by a visible light non-transmissive adhesive tape. The adhesive tape can be laminated to the backside of the reflector. The tape preferably covers the entire backside of the reflector and at least a portion of it extends beyond the edge of the reflector. The portion of the tape that extends beyond the edge of the reflector can be used to adhere the reflector to the backlight module frame. The portion of the tape that extends beyond the edge of the reflector can be located in areas susceptible to light leakage (for example, in areas where there are ports). In some embodiments, a plurality of tabs of the tape extends beyond the edge of the reflector. FIG. 2, for example, shows reflector laminate 250 wherein visible light non-transmissive tape 216 extends beyond the edge of reflector 210. In some embodiments, the tape may extend beyond the entire perimeter of the reflector on all four sides, effectively sealing all gaps and preventing nearly all light leakage. This embodiment can be particularly useful when the reflector is a multilayer interference reflector. In yet another embodiment, as shown in FIG. 3, in reflector laminate 350, the edges of visible light non-transmissive tape 316 are folded over the edges of reflector 310. FIG. 4 illustrates an embodiment wherein the edges of visible light non-transmissive tape 416 are folded over the edges of reflector 410 and wrap around onto its opposite side. Reflector laminate 450 can be adhered to the backlight module frame using an additional piece of tape or visible light non-transmissive tape 416 could be a double-sided tape.

The visible light non-transmissive tape transmits less than about 0.01%, less than about 0.001%, or less than about 0.0001% of visible light. The visible light non-transmissive tape may reflect or absorb visible light. In some embodiments, the tape is black. For example, the tape can comprise a black adhesive and/or a black backing. In some embodiments, the tape has an optical density of at least about 2, at least about 3, at least about 4, at least about 5, or at least about 6. Optical density can be measured with a densitometer such as, for example, a GretagMacBeth D200-II densitometer. As will be appreciated by one of skill in the art, the required optical density of the tape will be depend upon the other components of the reflector laminate. For example, a reflector with very little optical density will require a tape with a higher optical density. In some applications, the reflector laminate has an optical density from about 4 to about 6.

An example of a commercially available visible light non-transmissive tape is 3M™ 87502B, a 20 μm thick, single sided adhesive with a black backing, available from 3M Company.

For some applications, the visible light non-transmissive tape should be selected to prevent warping and curling. Preferably, the tape shrinks and expands at rates similar to the reflector material. Therefore, in some embodiments, the tape and the reflector are made of materials having similar thermal mechanical properties such as, for example, coefficient of thermal expansion (CTE), coefficient of hydgroscopic expansion (CGE) and shrinkage.

For example, when the reflector is ESR, it can be desirable to use a tape having a CTE (0° C. to 85° C.) of about 23 μm/(m*° C.) in the machine direction and transverse direction (thermomechanical analysis (TMA): 5° C./min, 120 to −40° C., 25° C. reference, Initial RH <20%, 24 mm length); a CGE of about 15 μm/(m*% RH) in the machine direction and about 16 μm/(m*% RH) in the transverse direction (dynamic mechanical analysis (DMA): 25° C., 20 to 80% RH steady-state); and/or shrinkage (30 min at 85° C.) of about −0.01% in the machine direction and about −0.05% in the transverse direction (TMA: 5° C./min, hold 85° C. for 30 min, 25° C. reference, Initial RH<20%, 24 mm length).

In some applications, it can be useful for the light non-transmissive tape to be a double-sided tape (that is, for the backside of the tape to also comprise adhesive). The adhesive backside could then be used to adhere the reflector laminate to another surface.

The reflector laminate can also optionally comprise a protection film on the visible light non-transmissive tape opposite the reflector. The protection film can be attached using a light pressure sensitive adhesive, with a double-sided tape or by electrostatic energy. One example of a useful protection film is a polyethylene terephthalate (PET) film approximately 50-100 microns thick.

The reflector laminates can be provided to backlight module makers in a roll format wherein multiple reflector laminates are on a liner sheet. They can also be provided as z-folded or fan-folded sheets. Alternatively, the reflector laminates can be provided as converted sheets.

Backlight modules incorporating the reflector laminate of the invention comprise a frame, a reflector laminated to a visible light non-transmissive adhesive tape, a light guide and a light source.

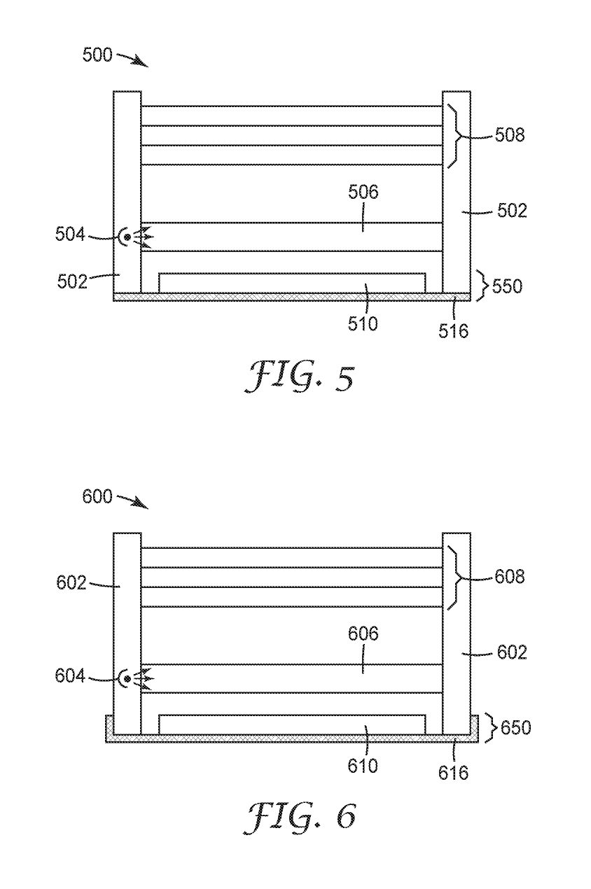

FIG. 5 shows an embodiment of a backlight module according to one aspect of the present invention. Backlight module 500 includes frame 502, light source 504, reflector laminate 550 and light guide 506. Reflector laminate 550 includes reflector 510 laminated to visible light non-transmissive tape 516. Frame 502 supports light source 504 and light guide 506 by their edges. Frame 502 can also support optional light recycling stacks and/or any other optical films.

Light source 504 is positioned to inject light into an edge of light guide 506. Light source 504 can be any light source including, for example, a cold cathode fluorescent lamp (CCFL) or LEDs. In some cases, LED light sources are preferred.

The light guide can be of any desired size or shape, and can be of uniform thickness such as a slab, or tapered such as a wedge. Extraction features can be provided on a front surface or elsewhere on or in the light guide, to direct light out of the light guide towards a liquid crystal panel or other component to be illuminated.

The light guide can include extraction features on the side opposite of the reflector, causing light to be directed toward the viewer at predetermined angles. Examples of extraction features can be found, for example, in U.S. Pat. No. 6,845,212 (Gardiner et al.) and U.S. Pat. No. 7,223,005 (Lamb et al.); and also in U.S. Patent Application Publication No. 2007-0279935 (Gardiner et al.). The extraction features can be grooves, lenslets, or other microstructured features designed to extract light from the light guide. The extraction features can be imparted to the light guide using several methods including, but not limited to, casting, embossing, microreplicating, printing, ablating, etching and other methods known in the art.

The light guide can be made from a glass or a polymeric material such as a thermoplastic or a thermoset polymer. In some cases, a thermoplastic suitable for the light guide is polycarbonate, but any suitable optically transmissive thermoplastic polymer can be used. The light guide can be a homopolymer, copolymer, or a polymer blend. In some cases, thermoset materials, such as radiation curable acrylates or methacrylates and the like can be used for the light guide. The light guide can be a flexible light guide or a rigid light guide. Flexible light guides are described, for example, in U.S. Patent Application Publication No. 2007-0279935 (Gardiner et al.).

In some cases, the light guide and the reflector are a single laminated unit. Appropriate selection of light guide and adhesive refractive indices can preserve light guiding and prevent light from entering the reflector at an angle greater than the leak angles. Light guides laminated to reflectors are described, for example, in WO 2009/045750 (Kinder et al.). Such laminates can be assembled using several different types of optically thick adhesive such as, for example, a dry-film hot melt adhesive, a dry-film pressure sensitive adhesive, a radiation curable adhesive, or a solvent based adhesive. The index of refraction of the optically thick adhesive is typically less than the index of refraction of the light guide. In some cases, the difference between the indices is greater than 0.005, for example, greater than 0.01, 0.1, 0.2 or more. The adhesive can form a continuous or a discontinuous layer between the light guide and the reflector.

Light injected into the edge of light guide 506 exits backlight 500 as extracted light and is directed toward optional light recycling film stack 508. Optional light recycling film stack 508 serves to further condition the light entering the LCD module and make more efficient use of the light to improve the brightness and uniformity of the display. Extracted light leaves backlight 500 from a front surface, and enters optional light recycling film stack 508.

Light recycling film stack 508 can include, for example, a pair of crossed Brightness Enhancement Films “BEF” prism films, available from 3M Company, oriented with the prisms facing the LCD module. Light recycling film stack 508 can also include an optional diffuser and an optional Dual Brightness Enhancement Film “DBEF” reflective polarizer, available from 3M Company, positioned on opposite sides of crossed BEF prism film. The optional diffuser can be positioned between crossed BEF prism films and the backlight. In some cases, optional light recycling film stack 508 can additionally include other films for further conditioning the light, such as diffusers, filters, and the like.

A portion of extracted light entering light recycling film stack 508, passes through the stack toward the LCD module. Another portion of the extracted light entering light recycling film stack 508 is directed back into backlight 500 through the front surface of light guide 506 as recycled light. Recycled light enters the front surface of light guide 506 and propagates through light guide 506. Recycled light is eventually reflected from reflector laminate 550 and directed back toward the front surface.

In traditional backlight modules, some light can leak from gaps between the reflector and the frame. In addition, particularly when the reflector is a multilayer interference reflector, some light can leak from the edge of the reflector. The present invention provides a reflector laminate that can minimize or eliminate light leak. The visible-light non-transmissive adhesive tape of the reflector laminate can seal gaps between the reflector and the frame. The adhesive tape can also be used to seal the edges of the reflector, which is particularly useful when the reflector is a multilayer inference reflector. As shown in FIG. 6, in some embodiments, visible light non-transmissive tape 616 can be adhered to the sides of frame 602. An additional benefit in this embodiment is that dust and debris are prevented from entering into the backlight.

### EXAMPLES

Objects and advantages of this invention are further illustrated by the following examples, but the particular materials and amounts thereof recited in these examples, as well as other conditions and details, should not be construed to unduly limit this invention.

Enhanced Specular Reflector (ESR, available from 3M Company, St Paul, Minn.) was laminated to a low tack adhesive film using a nip roll laminator. A rotary die cutter was used to cut rectangular sections, about 55 mm×95 mm in size, into the ESR layer. ESR material in the region surrounding the rectangles was removed onto an unwinding roll. The ESR rectangular sections were then laminated to a 60 micron thick adhesive web consisting of a polyester core with black pressure sensitive adhesive on both sides with the exposed surface of the ESR facing an exposed surface of the adhesive. There was a liner on the opposite side of the adhesive web. During this lamination step, the low tack adhesive film was removed from the ESR and a silicone release liner was introduced in its place. A separate rotary die cutting step was used to cut rectangular sections through the adhesive web. The rectangular sections through the adhesive web were centered with the rectangular regions in the ESR and sized so that the adhesive web extended past the edges of the ESR by about 0.8 mm on all sides. The result was an array of ESR rectangles on a silicone release liner with a black rectangular adhesive layer attached to each ESR rectangle, fully covering one side of the ESR rectangle and extending beyond the edges of the ESR rectangle.

The complete disclosures of the publications cited herein are incorporated by reference in their entirety as if each were individually incorporated. Various modifications and alterations to this invention will become apparent to those skilled in the art without departing from the scope and spirit of this invention. It should be understood that this invention is not intended to be unduly limited by the illustrative embodiments and examples set forth herein and that such examples and embodiments are presented by way of example only with the scope of the invention intended to be limited only by the claims set forth herein as follows.

1. A reflector laminate comprising:
(a) a reflector having a first major surface and a second major surface opposite the first major surface; and
(b) a visible light non-transmissive adhesive tape having a major adhesive surface and a second major surface; wherein the adhesive surface is in contact with the first major surface of the reflector and at least a portion of the adhesive tape extends beyond the edge of the reflector.

2. The reflector laminate of claim 1 wherein the reflector comprises a multilayer interference reflector.

3. The reflector laminate of claim 2 wherein the reflector comprises a polymeric multilayer interference reflector.

4. The reflector laminate of claim 3 wherein the reflector comprises an Enhanced Specular Reflector film.

5. The reflector laminate of claim 1 wherein a plurality of tabs extend beyond the edge of the reflector.

6. The reflector laminate of claim 1 wherein the adhesive tape extends beyond the entire perimeter of the reflector.

7. The reflector laminate of claim 1 wherein at least a portion of the adhesive tape is wrapped around at least a portion of the edge of the reflector.

8. The reflector laminate of claim 1 wherein the adhesive tape reflects visible light.

9. The reflector laminate of claim 1 wherein the adhesive tape absorbs visible light.

10. The reflector laminate of claim 9 wherein the adhesive tape is black.

11. The reflector laminate of claim 10 wherein the adhesive tape comprises a black adhesive.

12. The reflector laminate of claim 10 wherein the adhesive tape comprises a black backing.

13. The reflector laminate of claim 1 wherein the second major surface of the tape comprises adhesive.

14. The reflector laminate of claim 1 further comprising a protection film adjacent the second major surface of the adhesive tape.

15. The reflector laminate of claim 1 wherein the reflector laminate is adhered to a backlight frame by the adhesive tape extending beyond the perimeter of the reflector.

16. The reflector laminate of claim 15 wherein the adhesive tape wraps around at least a portion of the reflector and the backlight frame.

17. The reflector laminate of claim 1 wherein the adhesive tape extending beyond the edges of the reflector wraps around the edge of the reflector and folds back onto a portion of the second major surface of the reflector.

18. A backlight module comprising:
a frame;
a reflector having a first major surface and a second major surface opposite the first major surface;
a visible light non-transmissive adhesive tape having a major adhesive surface and a second major surface, wherein the adhesive surface is in contact with the first major surface of the reflector and at least a portion of the adhesive tape extends beyond the edge of the reflector to attach the reflector to the frame;
a light guide positioned proximate the second major surface of the reflector; and
a light source for injecting light into an edge of the light guide.

19. The backlight module of claim 18 further comprising a light recycling stack positioned proximate the light guide and opposite the reflector.

20. The backlight module of claim 19 wherein the light recycling stack comprises at least one optical film selected from a diffuser, a prismatic film, a reflective polarizer film and combinations thereof.

21. The backlight module of claim 18 wherein the reflector comprises a multilayer interference reflector.

22. The backlight module of claim 18 wherein the adhesive tape completely seals the reflector to the frame.
